(19) United States
(12) Patent Application Publication
(10) Pub. No.: US 2015/0004557 A1
(43) Pub. Date: Jan. 1, 2015

(54) METHOD, SYSTEM, AND ARTICLE OF MANUFACTURE FOR THE USAGE OF DENTAL IMAGERY RECEIVED OVER A NETWORK FROM A DENTAL DEVICE

(71) Applicant: ORMCO CORPORATION, Orange, CA (US)

(72) Inventors: Mark A. HILLEBRANDT, Newport Beach, CA (US); Steven SCHWARZ, HILVERSUM (NL); Brandy M. LEWIS, Newport Beach, CA (US)

(21) Appl. No.: 14/320,276

(22) Filed: Jun. 30, 2014

Related U.S. Application Data
(60) Provisional application No. 61/841,810, filed on Jul. 1, 2013.

(51) Int. Cl. G06Q 50/22; G06Q 20/22; G06Q 30/06; G06Q 30/02; A61C 7/00; A61C 9/00

(52) U.S. Cl. CPC G06Q 50/22; A61C 7/002; A61C 9/0046; G06Q 30/0601; G06Q 30/0207; G06Q 20/29
USPC 433/29; 705/2

(57) ABSTRACT

Provided are a method, system, and article of manufacture in which a server computational device establishes communications over a network with a dental imaging system. An order is received to fabricate a dental device based on dental imagery acquired via the dental imaging system. A discount based on a cost of fabrication of the dental device is computed and communicated. Provided also is an intra-oral imaging system, where the intra-oral imaging system comprises an intra-oral imaging sensor, a display, and a processor coupled to the intra-oral imaging sensor and the display. The intra-oral imaging device acquires dental imagery, and establishes communications over a network with a server computational system. The intra-oral imaging device sends, an order to fabricate a dental device based on the acquired dental imagery, and receives communications of a discount based on a cost of fabrication of the dental device.

### 1. FIELD

The disclosure relates to a method, system, and computer readable storage medium for the usage of dental imagery received over a network from a dental device.

### 2. BACKGROUND

An intra-oral imaging system is a type of dental device and is a diagnostic equipment that allows a dental practitioner to see the inside of a patient's mouth and display the topographical characteristics of teeth on a display monitor. Certain three-dimensional (3D) intra-oral imagers may be comprised of an intra-oral camera with a light source. The 3D intra-oral imager may be inserted into the oral cavity of a patient by a dental practitioner. After insertion of the intra-oral imager into the oral cavity, the dental practitioner may capture images of visible parts of the teeth and the gingivae.

The 3D intra-oral imager may be fabricated in the form of a slender rod that is referred to as a wand or a handpiece. The wand may be approximately the size of a dental mirror with a handle that is used in dentistry. The wand may have a built-in light source and a video camera that may achieve an imaging magnification, ranging in scale from 1 to 40 times or more. This allows the dental practitioner to discover certain types of details and defects of the teeth and gums. The images captured by the intra-oral camera may be displayed on a television or a computer monitor.

The wand may be attached or linked to a computer and a display monitor. The wand, the computer, and the display monitor may all be placed in the proximity of the patient before the dental practitioner places the tip of the wand inside the oral cavity of the patient and starts acquiring images. The acquired images may be displayed on the display monitor and transmitted to a remote computational device for additional processing and storage.

Orthodontics is a specialty of dentistry that is concerned with improvement of the general appearance of a patient's teeth and also the correction of malocclusions, crookedness and other flaws of the teeth. Orthodontic braces are devices that are placed on a patient's teeth by a dental practitioner. In an orthodontic brace, wires interact with brackets to move teeth to a desired position. Often, such orthodontic braces are periodically adjusted by the dental practitioner to help align and straighten the teeth. Treatment by the dental practitioner may help in repositioning the teeth to correct flaws and improve the general appearance of the patient. Another method of orthodontic treatment may use a series of clear, removable teeth aligners as an alternative to orthodontic braces. A series of teeth aligners are successively worn by the patient to reposition the teeth to correct flows.

A dental practitioner may write a prescription for a patient, based on an analysis of the intra-oral imagery acquired by the intra-oral imaging system. The prescription and the intra-oral imagery may be transmitted from the intra-oral imaging system to a remote computational server where the prescription written by the dental practitioner and the intra-oral imagery may be analyzed and may be used to manufacture orthodontic braces, aligners, or other dental devices. These braces, aligners, or other dental devices may then be shipped to the dental practitioner.

### SUMMARY OF THE PREFERRED EMBODIMENTS

Provided are a method, system, and article of manufacture in which a server computational device establishes communications over a network with a dental imaging system. An order is received to fabricate a dental device based on dental imagery acquired via the dental imaging system. A discount based on a cost of fabrication of the dental device is computed and communicated.

In additional embodiments, a reduction is made of a periodic payment for the dental imaging system by the amount of the discount.

In further embodiments, the dental imaging system is an intra-oral imaging system, and the dental device to be fabricated comprises brackets and wires.

In yet further embodiments, the order to fabricate the dental device is received by the server computational device from the dental imaging system.

In still further embodiments, a check or an electronic payment is sent based on the amount of the discount.

In additional embodiments, the check or the electronic payment based on the amount of the discount is sent subsequent to the dental imaging system being fully paid for.

In certain embodiments, a selection for sending the order to the server computational device with an indication of the discount is displayed on a display screen of the intra-oral imaging system.

In additional embodiments, the server computational device stores the dental imagery in a format suitable for being interpreted by devices that are different from the server computational device, wherein no discount or charges are applied for the storing.

In further embodiments the format is a Standard Tessellation Language (STL) file format.

In additional embodiments, the dental imaging system is associated with an account number, wherein the discount is associated with the account number. In response to a replacement of the dental imaging system by a new dental imaging system, the new dental imaging system is associated with the account number.

In further embodiments, the discount is a function of a number of orders previously placed.

Provided also is an intra-oral imaging system configured for communication with a server computational system, where the intra-oral imaging system comprises an intra-oral imaging sensor, a display, and a processor coupled to the intra-oral imaging sensor and the display, wherein the processor performs operations, the operations comprising: acquiring dental imagery; establishing, communications over a network with the server computational system; sending, an order to fabricate a dental device based on the acquired dental imagery; and receiving communications of a discount based on a cost of fabrication of the dental device.

In additional embodiments, a periodic payment for the dental imaging system is reduced by the amount of the discount.

In further embodiments, a check or an electronic payment based on the amount of the discount is received, subsequent to the intra-oral imaging system being fully paid for.

### BRIEF DESCRIPTION OF THE DRAWINGS

Referring now to the drawings in which like reference numbers represent corresponding parts throughout:

FIG. 1 illustrates a block diagram of a server computational device coupled to an intra-oral imaging system over a network, in accordance with certain embodiments;

FIG. 2 illustrates an intra-oral imaging system, in accordance with certain embodiments;

FIG. 3 illustrates a block diagram of a discount mechanism associated with the acquisition of an intra-oral imaging system, in accordance with certain embodiments;

FIG. 4 illustrates a block diagram of a server computational system, in accordance with certain embodiments;

FIG. 5 illustrates a flowchart that shows operations for providing discounts associated with the acquisition and usage of an intra-oral imaging system, in accordance with certain embodiments;

FIG. 6 illustrates a flowchart that shows operations performed by an intra-oral imaging system and a server computational system, in accordance with certain embodiments;

FIG. 7 illustrates a block diagram that shows operations related to the replacement of an intra-oral imaging system, in accordance with certain embodiments;

FIG. 8 illustrates a block diagram that shows exemplary indications displayed on the display of an intra-oral imaging system, in accordance with certain embodiments;

FIG. 9 illustrates a flowchart that shows certain operations, in accordance with certain embodiments; and

FIG. 10 illustrates a block diagram of a computational system, in accordance with certain embodiments.

### DETAILED DESCRIPTION

In the following description, reference is made to the accompanying drawings which form a part hereof and which illustrate several embodiments. It is understood that other embodiments may be utilized and structural and operational changes may be made.

Acquisition and usage mechanism for an intra-oral imaging system

An intra-oral imaging system is an expensive system that may cost tens of thousands of dollars or more to purchase. A dental practitioner may acquire dental imagery of a patient via the intra-oral imaging system. The manufacturer of the intra-oral imaging system may prefer that dental devices (e.g., braces, aligners, etc.) that are to be ordered based on the acquired dental imagery be sent to the manufacturer by the dental practitioner. Such orders may also be expensive and may cost hundreds of dollars.

The manufacturer of the intra-oral imaging system may provide a disincentive to the dental practitioner to dissuade him from sending orders for device fabrication to other manufacturers. The manufacturer of the intra-oral imaging system may provide the disincentive to the dental practitioner by charging additional amounts of money for storing the dental images in an open format [e.g., Standard Tessellation Language (STL)] in a server maintained under the control of the manufacturer of the intra-oral imaging system. The dental practitioner may find such practices of the manufacturer disagreeable.

In certain embodiments, instead of charging money for storing dental imagery for sending orders to other manufacturers, the manufacturer of the intra-oral imaging system may store the dental imagery free of charge in open formats and may also provide a discount off a predetermined price for dental device fabrication orders, when such dental device fabrication orders are sent to the manufacturer.

In certain embodiments in which dental practitioner makes periodic payments to the manufacturer for amortizing or otherwise defraying the cost of the intra-oral imaging system, the periodic payments may be reduced by the amount of the discounts. If the intra-oral imaging system has been fully paid for, the manufacturer may send a check or electronic payment to the dental practitioner. The dental practitioner has an incentive to send as much work as possible to the manufacturer of the intra-oral imaging system. Additionally, the dental practitioners may find such incentive schemes very agreeable, as there is no extra charge from the manufacturer of the intra-oral imaging system, even if dental device fabrication orders are sent to entities that are different from the manufacturer of the intra-oral imaging system. Additionally, the more the amount of work sent by a dental practitioner to the manufacturer of the intra-oral imaging system the greater is the amount of discounts provided to the dental practitioner.

### Exemplary Embodiments

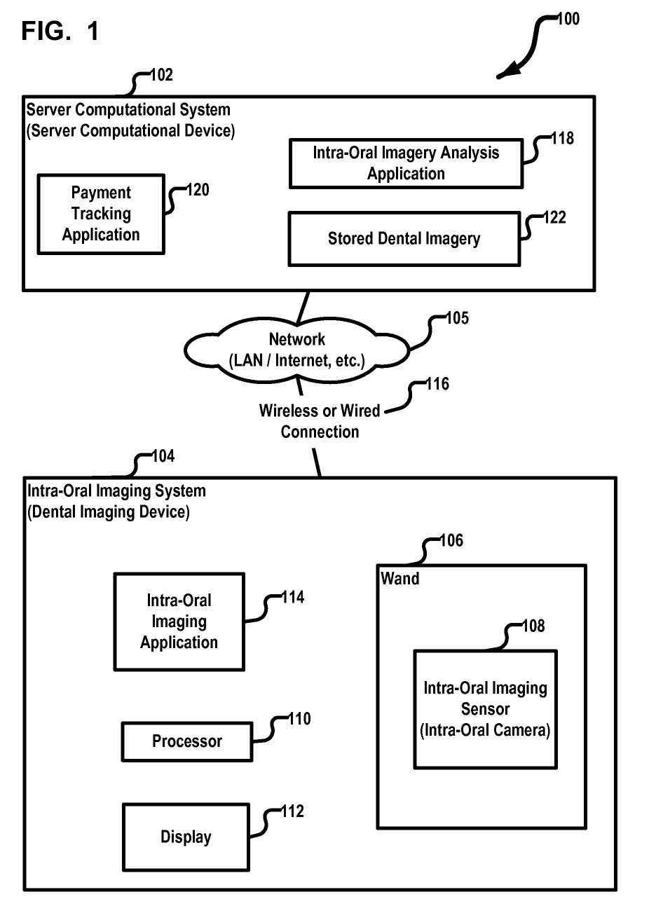

FIG. 1 illustrates a block diagram 100 of a server computational system 102 coupled to an intra-oral imaging system 104 over a network 105, in accordance with certain embodiments. The intra-oral imaging system 104 has a wand 106 with an intra-oral imaging sensor 108 for capturing images of a patient's teeth.

The intra-oral imaging system 104 is comprised of a processor 110, a display 112, a wand 106, and an intra-oral imaging application 114. The intra-oral imaging system 104 may be coupled via a wired or wireless connection 116 over the network 105 to the server computational system 102. The server computational system 102 may include any suitable computational device such as a personal computer, a server computer, a mini computer, a mainframe computer, a blade computer, a tablet computer, a touchscreen computing device, a telephony device, a cell phone, a mobile computational device, etc., and in certain embodiments the server computational system 102 may provide web services or cloud computing services. In certain embodiments, the server computational system 102 may also be referred to as a server computational device 102. The network 105 may comprise any suitable network known in the art such as a local area network, an intranet, the Internet, a storage area network, etc., and the network 105 may be used in a cloud computing environment.

A dental practitioner may hold the wand 106 inside a patient's oral cavity. An optical source coupled to the wand 106 may illuminate the oral cavity and the intra-oral imaging sensor 108 may be used to capture a plurality of digital images of structures in the oral cavity, such as the patient's teeth, gingivae, and/or palate, and other structures, such as fillings, braces, etc. In certain embodiments the intra-oral imaging sensor 108 may comprise an intra-oral camera.

The operation of the wand 106 and the acquisition of the intra-oral imagery may be controlled by the intra-oral imaging application 114 that may be implemented in certain embodiments in software, hardware, firmware or any combination thereof. The intra-oral imaging application 114 may process the images acquired by the intra-oral imaging sensor 106 and display the images on the display 112, where the display 112 may comprise a touchscreen display. In certain alternative embodiments, additional or alternative processing of the images acquired by the intra-oral imaging sensor 106 and the camera 108 may be performed over the network 105 by the server computational system 102, and the intra-oral imaging application 114 may then display the results of the processing of the images on the display 112.

The server computational system 102 includes an intra-oral imagery analysis application 118 and a payment tracking application 120. The server computational system 102 also stores dental imagery 122 that has been acquired and transmitted to the server computational system 102 by the intra-oral imaging system 104.

Therefore, FIG. 1 illustrates certain embodiments in which an intra-oral imaging system 104 and a server computational system 102 may be configured to be in communication with each other. In certain embodiments the payment tracking application 120 determines how much monetary or other incentive to provide to a dental practitioner who sends intra-oral images acquired by the intra-oral imaging system 104 to the server computational system 102 for the fabrication of dental appliances.

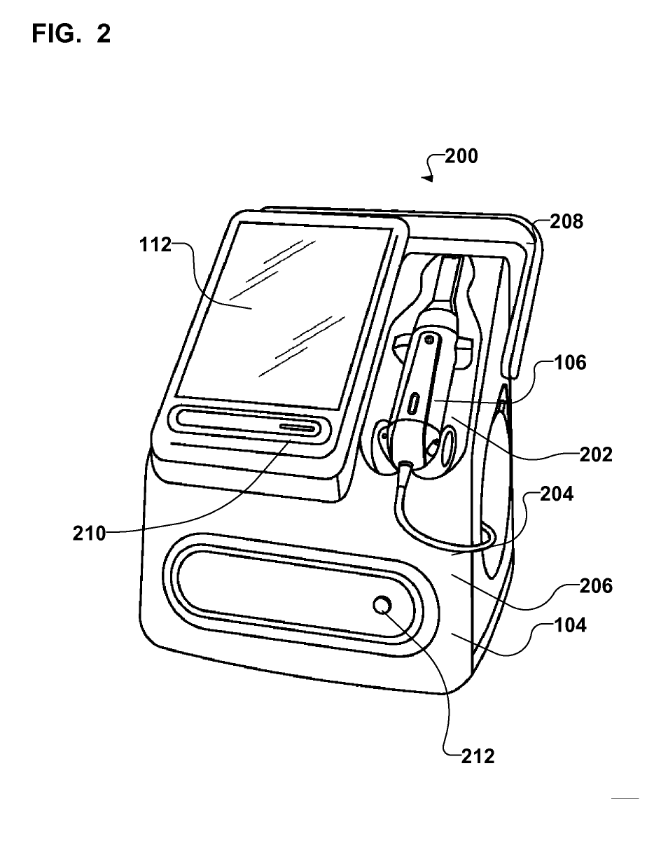

FIG. 2 illustrates a view 200 of an exemplary intra-oral imaging system 104 in which the wand 106 having the intra-oral imaging sensor 108 is included, in accordance with certain embodiments. It should be noted that intra-oral imaging system 104 is exemplary and other intra-oral imaging systems may be used in alternative embodiments.

The intra-oral imaging system 104 may include a wand 106 having the intra-oral imaging sensor 108. The wand 106 is small and light weight for use by dental practitioners, and the intra-oral imaging process is fast and relatively simple to use, allowing the imaging of both arches and bites to be accomplished rapidly, such that a digital model of the imaged areas may be viewed on the display 112, where in certain embodiments the display 112 is a touchscreen display.

The intra-oral imaging system 104 may include a wand storage area 202 in which the wand 106 may be stored. The wand 106 may be extensibly coupled via a cord 204 to the housing 206 of the intra-oral imaging system 104.

The intra-oral imaging system 104 may include a handle 208 that may be used for carrying the intra-oral imaging system 104 from one location to another. The handle 208 may also be referred to as a carrying handle.

In addition to the handle 208, the display 112, the wand 106, and the housing 206, the intra-oral imaging system 104 includes a power button 212 that is located on the front face of the intra-oral imaging system 104. The power button 212 may be used to switch the intra-oral imaging system 104 on and off. Additionally, light emitting diode (LED) based indicators 210 may indicate one or more status related to the operational state of the intra-oral imaging system 104.

Therefore, FIG. 2 illustrates certain embodiments in which an intra-oral imaging system 104 includes a wand 106 that includes an intra-oral imaging sensor 108 for acquiring dental imagery and for transmitting the dental imagery to the server computational system 102.

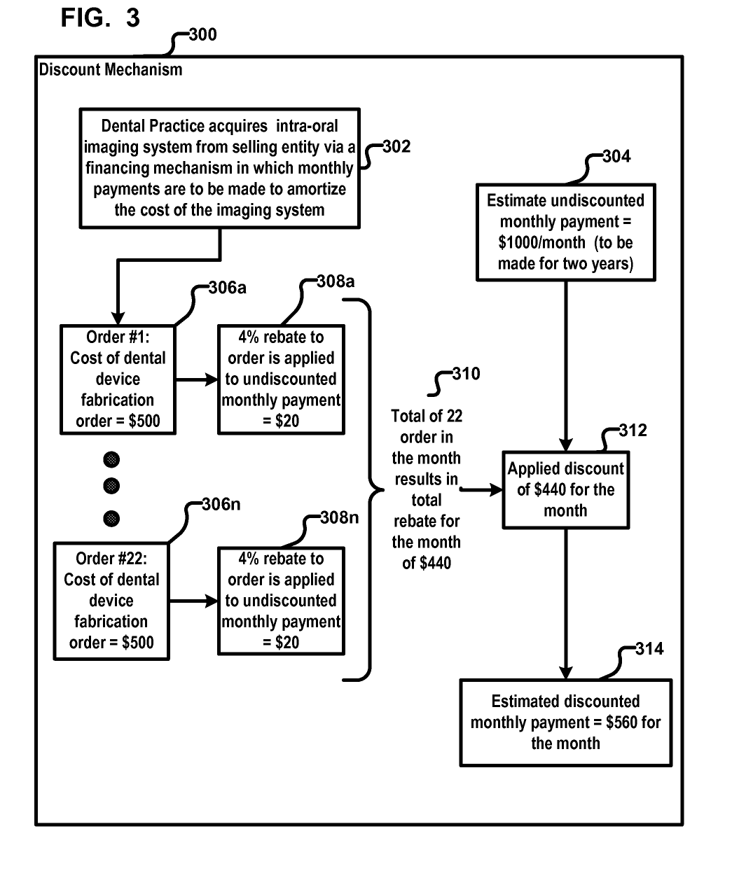

FIG. 3 illustrates a block diagram 300 of a discount mechanism associated with the acquisition of an intra-oral imaging system 104, in accordance with certain embodiments.

A dental practice (or a dental practitioner or some other purchasing entity) may acquire (at block 302) an intra-oral imaging system 104 from a selling entity via a financing mechanism in which monthly payments are to be made to amortize or otherwise defray the cost of the intra-oral imaging system 104. The selling entity may be the manufacturer, or some other entity that is an agent of the manufacturer or has been otherwise authorized by the manufacturer. The selling entity may comprise also a reseller of the intra-oral imaging system 104.

In certain embodiments, the estimated undiscounted monthly payment 304 for fully paying for the intra-oral imaging system 104 may be $1000. In certain embodiments, such monthly payments have to be made for two years for fully amortizing the cost of the intra-oral imaging system 104. Other types of payment terms may be used in alternative embodiments.

A dental practitioner may over the period of a month, place 22 orders for device fabrication as shown via reference numerals 306a . . . 306n, where each order for device fabrication costs $500. The cost of $500 may be a predetermined cost that is listed and is for fabricating a device from intra-oral imagery or from a dental impression. In certain embodiments, the selling entity may provide a 4% rebate (reference numerals 308a . . . 308n) on the cost of fabricating the dental device, where the rebate is applied to the undiscounted monthly payment of $2000. Since 4% of $500 is $20, for 22 orders the total rebate is 22 times 20, which equals $440 (reference numeral 310). In certain embodiments, the amount of $440 is the applied discount (reference numeral 312) to the undiscounted monthly payment of $1000 for the month, and therefore the discounted monthly payment for the month is $560 (reference numeral 314).

Therefore, in embodiments illustrated in FIG. 3 the monthly payment of $1000 is reduced to $560 because of the 22 orders that the dental practitioner placed with the manufacturer of the intra-oral imaging system 104 for fabrication of dental devices from images acquired by the intra-oral imaging system 104. It is reiterated that in alternative embodiments the payment terms for purchase of the intra-oral imaging system 104 may be different and the discounts may be designed differently. For example, in an alternative embodiment, there may be $4000 quarterly payments, and the rebate may be 2% for each order. In alternative embodiments, the rebate per order may increase when more orders are made. For example, for the first 1000 orders per year the rebate may be 2%, and on additional orders the rebate may be increased to 3%.

In alternative embodiments, the discount may be provided in a different manner. For example, instead of a monetary discount, reward points that are exchangeable for physical goods or gifts may be provided to the buyer of the intra-oral imaging system 104.

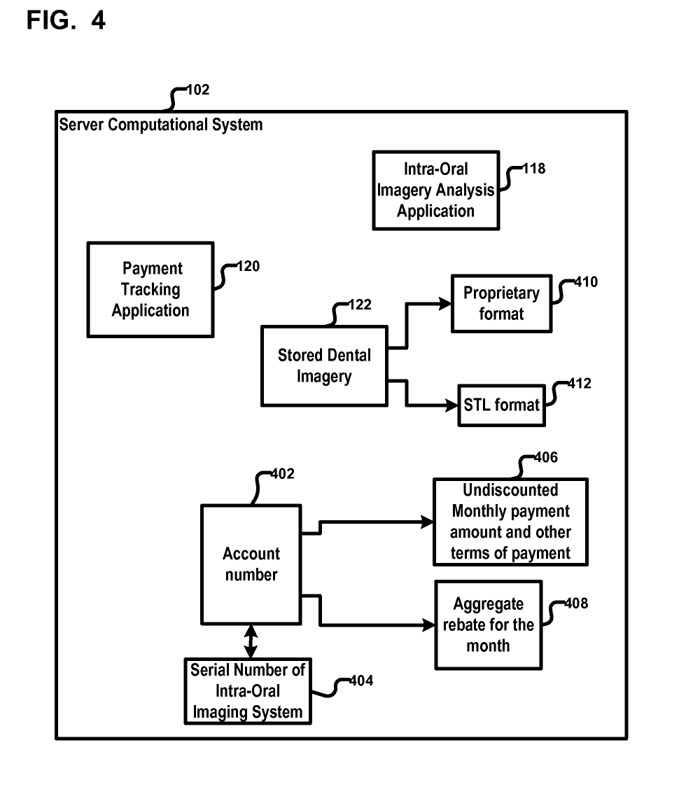

FIG. 4 illustrates a block diagram of a server computational system 102, in accordance with certain embodiments. The intra-oral imagery analysis application 118 analyzes intra-oral imagery received from an intra-oral imaging system 104 to design dental devices (e.g., braces, aligners, etc.) that are shipped to the dental practitioner. The payment tracking application 120 keeps track of the payments associated with an account number 402 with which the serial number 404 of the intra-oral imaging system 104 is associated. Associated with the account number 402 are the undiscounted monthly payment amount and other terms of payment (reference numeral 406) for the intra-oral imaging system 104 with serial number 404. The aggregate rebate (i.e., discount) for the month 408 is also stored in association with the account number 402.

The dental imagery 122 that is stored in the server computational system 102 may be stored in a proprietary format 410 or in an open format, such as, the STL format 412. If stored in the proprietary format 410, then only the manufacturer of the intra-oral imaging system 104 or entities authorized by the manufacturer are able to interpret the dental imagery 122, as the syntax of the proprietary format 410 is not publicly disclosed or is otherwise legally restricted from being used by unauthorized entities. The server computational system 102 may analyze the stored dental imagery 122 to generate the design for the manufacture of dental devices. The dental images stored in STL format 412 may under the dental practitioner's instructions be sent to another entity, and the manufacturer of the intra-oral imaging system 104 does not charge any additional amount for the service of storing the dental images in the STL format. In certain embodiments, dental imagery stored in STL format 412 may be downloaded by a dental practitioner to his computer and then transmitted to an entity that is different from the manufacturer of the intra-oral imaging system 104. The syntax of open format dental imagery is available publicly and many different entities may use such dental imagery for various purposes.

Therefore, FIG. 4 illustrates certain embodiments in which a server computational system 102 keeps track of incentives provided to a dental practitioner for sending dental device fabrication orders to the manufacturer of the intra-oral imaging system 104.

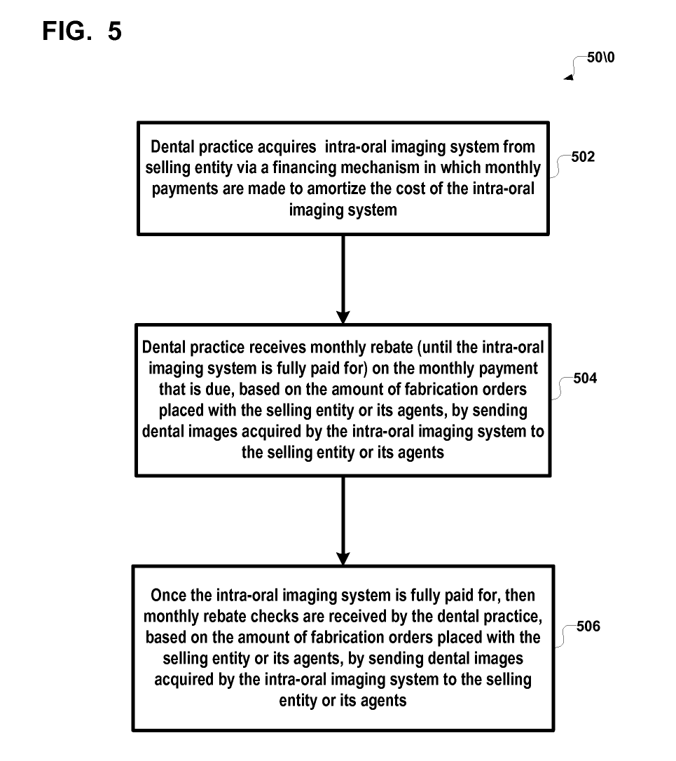

FIG. 5 illustrates a flowchart 500 that shows operations for providing discounts associated with the acquisition and usage of an intra-oral imaging system 104, in accordance with certain embodiments. Certain of the operations shown in FIG. 5 may be performed in the computing environment 100.

Control starts at block 502 in which a dental practice (or a dental practitioner or some other buyer) acquires an intra-oral imaging system 104 from a selling entity via a financing mechanism in which monthly payments are made to amortize the cost of the intra-oral imaging system 104.

The dental practice receives (at block 504) a monthly rebate (until the intra-oral imaging system 104 is fully paid for) on the monthly payment that is due, based on the amount of fabrication orders placed with the selling entity or its agents. The rebate may also be referred to as a discount. The fabrication orders are placed by sending dental images acquired by the intra-oral imaging system 104 to the server computational system 102 controlled by the selling entity or its agents.

Once the intra-oral imaging system is fully paid for, then monthly rebate checks or equivalent electronic payments are received (at block 506) by the dental practice, based on the amount of fabrication orders placed with the selling entity or its agents.

Therefore, FIG. 5 illustrates certain embodiments in which discounts are provided on the monthly payment corresponding to the acquisition of an intra-oral imaging system 104 if payments are still due. If no payments are due, then a check or electronic payment corresponding to the discount is sent to the dental practice.

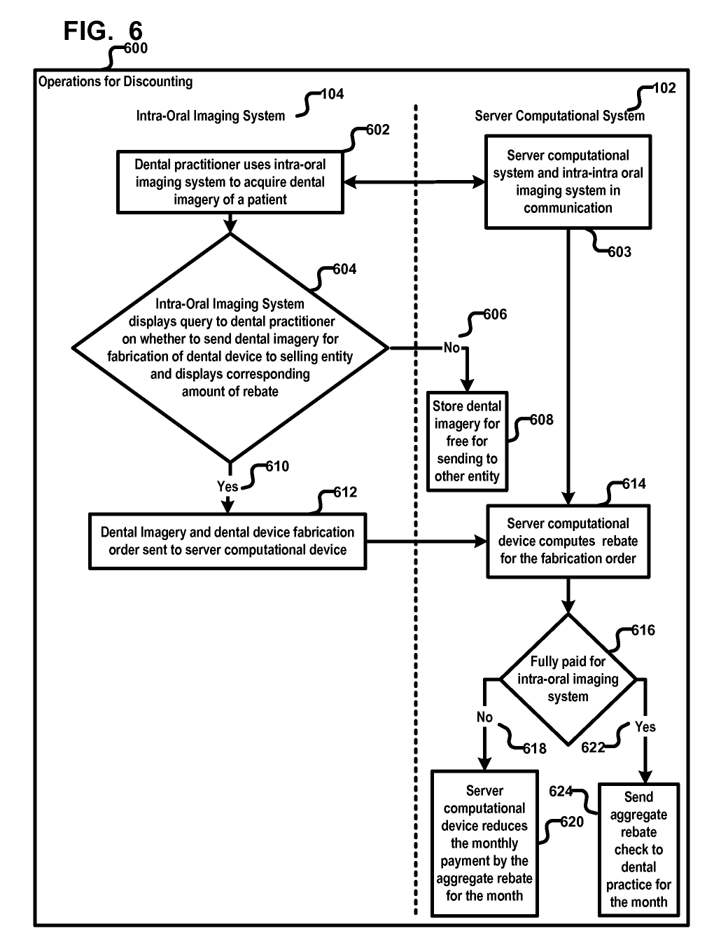

FIG. 6 illustrates a flowchart 600 that shows operations for discounting performed by an intra-oral imaging system 104 and a server computational system 102, in accordance with certain embodiments.

Control starts at block 602 in which a dental practitioner uses an intra-oral imaging system 104 to acquire dental imagery of a patient, where the intra-oral imaging system 104 and the server computational system 102 are in communication (block 603). Control proceeds to block 604 in which the intra-oral imaging system 104 displays a query to the dental practitioner on the display 112 of the intra-oral imaging system 104 on whether to send the dental imagery for fabrication of a dental device to the selling entity. Associated with the query, the corresponding amount of the rebate may also be displayed on the display 112.

If the dental practitioner chooses not to send (“No” block 606) the dental imagery for fabrication of a dental device to the selling entity, then the server computational system 102 stores (at block 608) the dental imagery in an open format for free for sending to other entities. The stored dental image may be in an open format, such as the STL format. In contrast to other schemes in which manufacturers charge for storing the dental imagery in an open format, certain embodiments make it advantageous for the dental practitioner by not charging the dental practitioner any additional amount for storing the dental imagery in an open format in the server computational system 102.

If the dental practitioner choose to send (“Yes” block 610) the dental imagery for fabrication of a dental device to the selling entity, then the dental imagery and dental device fabrication orders are sent (at block 612) over the network 105 to the server computational system 102 from the intra-oral imaging system 104. The server computational system 102 receives the dental imagery and the dental device fabrication order and computes (at block 614) amount of rebates for the fabrication order. Control proceeds to block 616 in which the server computation system 102 reviews the information associated with the account number 402 and determines (at block 616) whether the intra-oral imaging system 104 is fully paid for. If not (“No” branch 618), the server computational system 102 reduces (at block 620) the monthly payment of the dental practitioner by the aggregate rebate for the month. If the intra-oral imaging system 104 is fully paid for (“Yes” branch 622) then the server computational system 102 issues a command to send (at block 624) an aggregate rebate check or equivalent electronic payment to the dental practitioner for the month.

Therefore, FIG. 6 illustrates certain embodiments in which the intra-oral imaging system 104 and the server computational system 102 interact with each other, prior to the dental practitioner receiving reduced monthly payments or rebate checks.

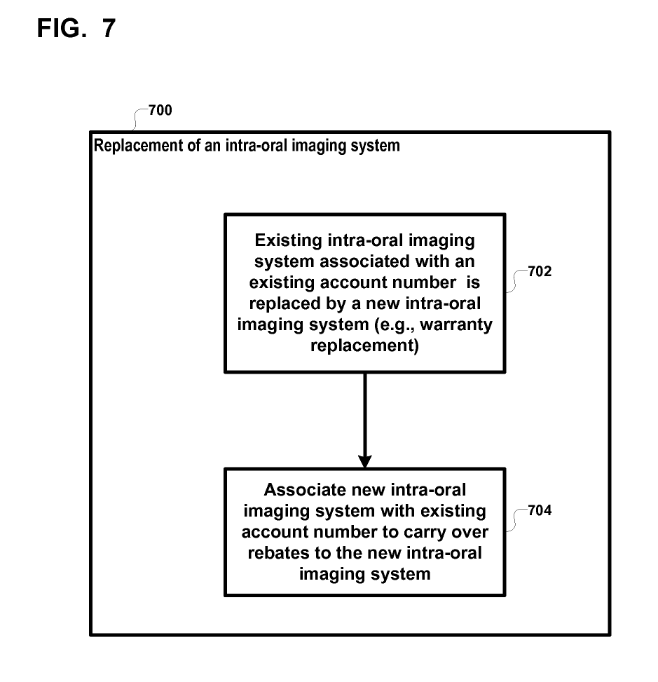

FIG. 7 illustrates a block diagram 700 that shows operations related to the replacement of an intra-oral imaging system 104, in accordance with certain embodiments.

Control starts at block 702 in which an existing intra-oral imaging system 104 associated with an existing account number is replaced by a new intra-oral imaging system. For example, a malfunction of the existing intra-oral imaging system 104 may cause the manufacturer to provide a warranty replacement. The server computational system 102 associates (at block 704) the new intra-oral imaging system with the existing account number to carry over rebates to the new intra-oral imaging system.

Therefore, FIG. 7 illustrates certain embodiments in which rebates are carried over an existing intra-oral imaging system to a new intra-oral imaging system by associating the replacement intra-oral imaging system with the existing account number of the existing intra-oral imaging system that is replaced The association of intra-oral imaging systems with a unique account number assists in maintaining and carrying over the rebate information to the new intra-oral imaging system.

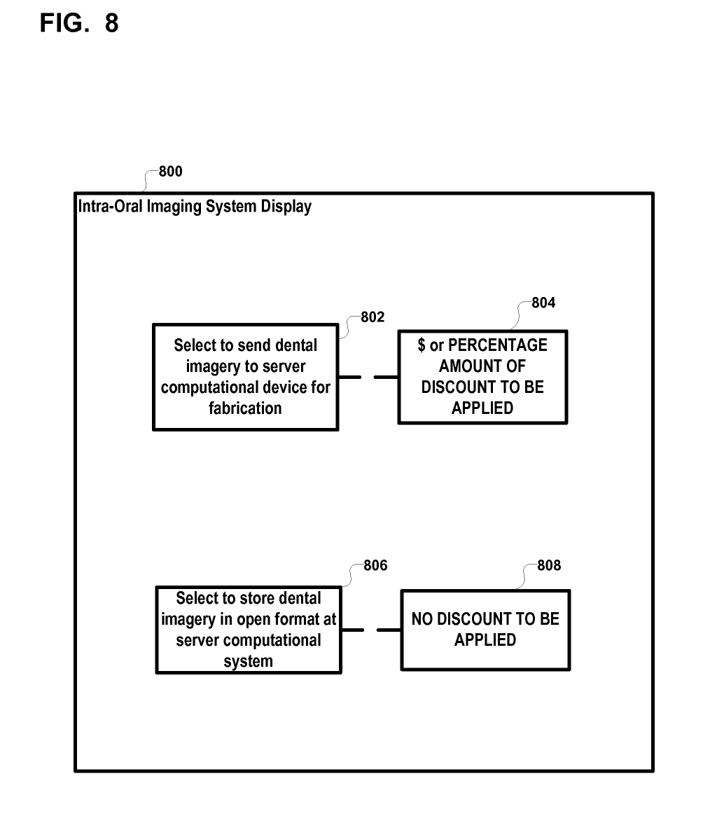

FIG. 8 illustrates a block diagram that shows exemplary indications 800 displayed on the display 112 of an intra-oral imaging system 104, in accordance with certain embodiments. The indications 800 may be displayed via communications conducted between the server computational system 102 and the intra-oral imaging system 104.

A first indication 802 is a selection that indicates “Select to send dental imagery to server computational system for fabrication” and an associated indicator 804 provides the dollar or percentage amount of discount to be potentially applied. The display of the discount to be potentially applied may encourage the dental practitioner to send the fabrication order to the manufacturer of the intra-oral imaging system 104.

A second indication 806 is a selection that indicates “Select to store dental imagery in open format at server computational system” and an associated indicator 808 provides information that no discounts are to be applied. The display of the information that no discount is to be applied may potentially discourage the dental practitioner to store the dental imagery in an open format for sending to another entity that is different from or not authorized by the manufacturer of the he intra-oral imaging system 104.

Therefore, FIG. 8 illustrates certain indicators that are displayed for encouraging a dental practitioner to send dental device fabrication orders to the manufacturer of the intra-oral imaging system 104. If the selection 802 for sending a fabrication order is regarded as a “click” then certain embodiments relate to a “pay per click” with a discount mechanism when a fabrication order is sent to the manufacturer of the intra-oral imaging system. It should be noted that the specific wording or manner in which such indicators are presented may be different in different embodiments. Pop-ups, flashing texts, and other types of graphical user interfaces may be used to present the indicators to catch the attention of the dental practitioner.

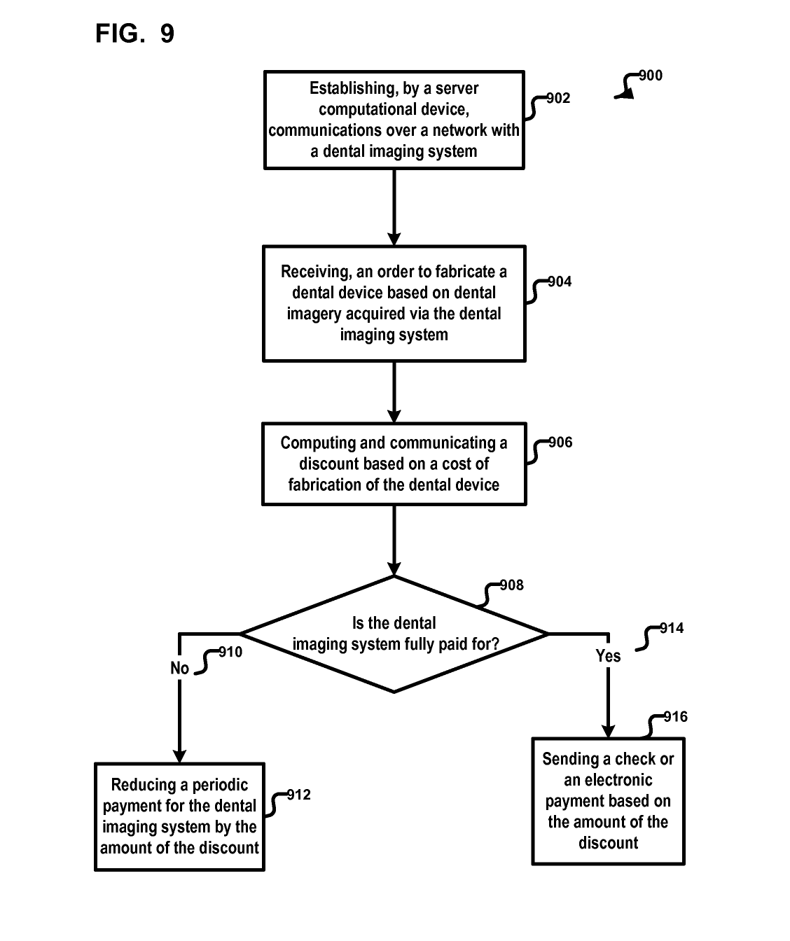

FIG. 9 illustrates a flowchart 900 that shows certain operations, in accordance with certain embodiments. The operations shown by FIG. 9 may be performed by the server computational system 102.

Control starts at block 902 in which a server computational device (e.g., the server computational system 102) establishes communications over a network 105 with a dental imaging system (e.g., the intra-oral imaging system 104). An order is received (at block 904) to fabricate a dental device based on dental imagery acquired via the dental imaging system 104. A discount based on a cost of fabrication of the dental device is computed and communicated (at block 906). The term discount may correspond to rewards, incentives, refunds, pay-backs, cash-backs, money-backs, money-returns, loyalty points, reward points, rebates, or other similar mechanisms and may be monetary or non-monetary in form.

Control proceeds to block 908, in which the server computational device 102 determines whether the dental imaging system 104 is fully paid for. If not (“No” branch 910) a periodic payment for the dental imaging system is reduced (at block 912) by the amount of the discount. If the dental imaging system 104 is fully paid for (“Yes” branch 914) then a check or electronic payment based on the amount of the discount is sent (at block 916) to the dental practitioner.

Therefore, FIGS. 1-9 illustrate certain embodiments in which incentives are provided to a dental practitioner to send fabrication orders for dental devices to the manufacturer of the intra-oral imaging system 104. The incentives may comprise a reduction in the monthly payment for amortizing or defraying the cost of the intra-oral imaging system, or a check (or other electronic payment).

As a result, the dental practitioner may feel more encouraged to purchase and use the intra-oral imaging system 104 for placing dental device fabrication orders with the manufacturer of the intra-oral imaging system 104, in comparison to schemes in which the dental practitioner is required to pay additional amounts to store dental imagery in an open format in the sever computational device 102 and also not receive any discounts on orders placed with the manufacturer.

### Additional Details of Embodiments

Certain operations described in the figures may be implemented as a method, apparatus or computer program product using techniques to produce software, firmware, hardware, or any combination thereof. Additionally, certain embodiments may take the form of a computer program product embodied in one or more computer readable storage medium(s) having computer readable program code embodied therein.

A computer readable storage medium may include an electronic, magnetic, optical, electromagnetic, or semiconductor system, apparatus, or device, or any suitable combination of the foregoing. The computer readable storage medium may also comprise an electrical connection having one or more wires, a portable computer diskette or disk, a hard disk, a random access memory (RAM), a read-only memory (ROM), an erasable programmable read-only memory (EPROM or Flash memory), a portable compact disc read-only memory (CD-ROM), an optical storage device, a magnetic storage device, etc. A computer readable storage medium may be any tangible medium that can contain, or store a program for use by or in connection with an instruction execution system, apparatus, or device.

A computer readable signal medium includes a propagated data signal with computer readable program code embodied therein. A computer readable signal medium may be any computer readable medium that is not a computer readable storage medium and that can communicate, propagate, or transport a program for use by or in connection with an instruction execution system, apparatus, or device. The computer readable storage medium is different from the computer readable signal medium.

Computer program code for carrying out operations for aspects of the present invention may be written in any combination of one or more programming languages.

Aspects of the present invention are described below with reference to flowchart illustrations and/or block diagrams of methods, system and computer program products according to certain embodiments. At least certain operations that may have been illustrated in the figures show certain events occurring in a certain order. In alternative embodiments, certain operations may be performed in a different order, modified or removed. Additionally, operations may be added to the above described logic and still conform to the described embodiments. Further, operations described herein may occur sequentially or certain operations may be processed in parallel. Yet further, operations may be performed by a single processing unit or by distributed processing units. Computer program instructions can implement the blocks of the flowchart. These computer program instructions may be provided to a processor of a computer for execution.

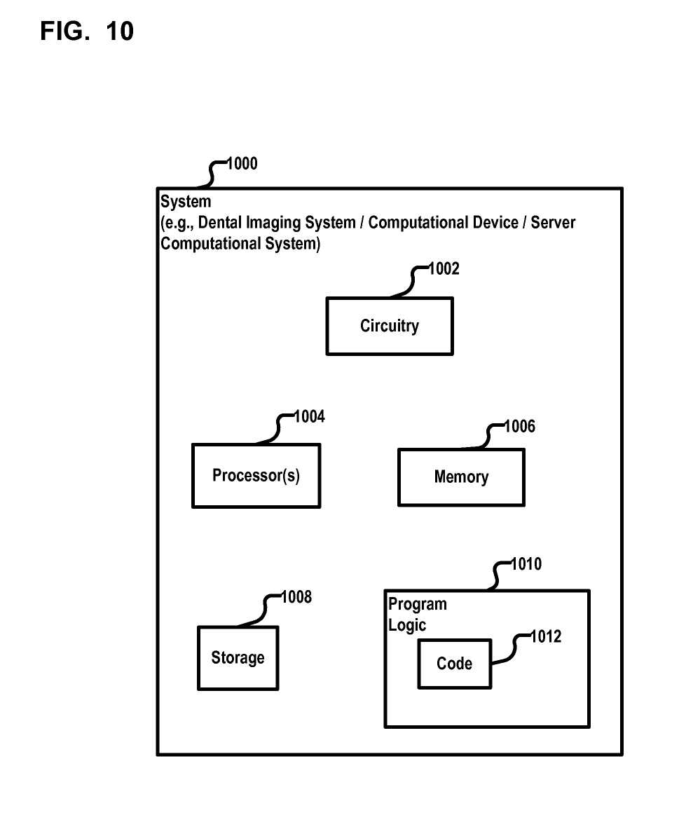

FIG. 10 illustrates a block diagram of a computer system 1000 that is used to provide incentives for placing dental device fabrication orders with a manufacturer of the intra-oral imaging system 104, in accordance with certain embodiments. The computer system 1000 may correspond to the server computational system 102 or the dental imaging system 104. The system 1000 may include a circuitry 1002 that may in certain embodiments include at least a processor 1004. The processor 1004 may comprise any suitable processor known in the art, such as, an arithmetic logical unit, a central processing unit, a circuitry that perform operations, hardware that performs instructions of a computer program, a microprocessor, a parallel processor, an array processor, a vector processor, a transistorized central processing unit, a microcontroller, a logic circuitry, etc. Any device that manipulates digital information based on one or more operational instructions or in a predefined manner is an example of the processor 1004. The system 1000 may also include a memory 1006 (e.g., a volatile memory device), and storage 1008. The storage 1008 may include a non-volatile memory device (e.g., EEPROM, ROM, PROM, RAM, DRAM, SRAM, flash, firmware, programmable logic, etc.), magnetic disk drive, optical disk drive, tape drive, etc. The storage 1008 may comprise an internal storage device, an attached storage device and/or a network accessible storage device. The system 1000 may include a program logic 1010 including code 1012 that may be loaded into the memory 1006 and executed by the processor 1004 or circuitry 1002. In certain embodiments, the program logic 1010 including code 1012 may be stored in the storage 1008. In certain other embodiments, the program logic 1010 may be implemented in the circuitry 1002. Therefore, while FIG. 10 shows the program logic 1010 separately from the other elements, the program logic 1010 may be implemented in the memory 1006 and/or the circuitry 1002.

The terms “an embodiment”, “embodiment”, “embodiments”, “the embodiment”, “the embodiments”, “one or more embodiments”, “some embodiments”, and “one embodiment” mean “one or more (but not all) embodiments of the present invention(s)” unless expressly specified otherwise.

The terms “including”, “comprising”, “having” and variations thereof mean “including but not limited to”, unless expressly specified otherwise.

The enumerated listing of items does not imply that any or all of the items are mutually exclusive, unless expressly specified otherwise.

The terms “a”, “an” and “the” mean “one or more”, unless expressly specified otherwise.

Devices that are in communication with each other need not be in continuous communication with each other, unless expressly specified otherwise. In addition, devices that are in communication with each other may communicate directly or indirectly through one or more intermediaries.

A description of an embodiment with several components in communication with each other does not imply that all such components are required. On the contrary a variety of optional components are described to illustrate the wide variety of possible embodiments.

When a single device or article is described herein, it will be readily apparent that more than one device/article (whether or not they cooperate) may be used in place of a single device/article. Similarly, where more than one device or article is described herein (whether or not they cooperate), it will be readily apparent that a single device/article may be used in place of the more than one device or article or a different number of devices/articles may be used instead of the shown number of devices or programs. The functionality and/or the features of a device may be alternatively embodied by one or more other devices which are not explicitly described as having such functionality/features.

The foregoing description of various embodiments of the invention has been presented for the purposes of illustration and description. It is not intended to be exhaustive or to limit the invention to the precise form disclosed. Many modifications and variations are possible in light of the above teaching. It is intended that the scope of the invention be limited not by this detailed description, but rather by the claims appended hereto. The above specification, examples and data provide a complete description of the manufacture and use of the composition of the invention. Since many embodiments of the invention can be made without departing from the spirit and scope of the invention, the invention resides in the claims hereinafter appended.

What is claimed is:

1. A method, comprising:
establishing, by a server computational device, communications over a network with a dental imaging system;
receiving, an order to fabricate a dental device based on dental imagery acquired via the dental imaging system; and
computing and communicating a discount based on a cost of fabrication of the dental device.

2. The method of claim 1, the method further comprising:
reducing a periodic payment for the dental imaging system by the amount of the discount.

3. The method of claim 1, wherein:
the dental imaging system is an intra-oral imaging system; and
the dental device to be fabricated comprises brackets and wires.

4. The method of claim 1, wherein the order to fabricate the dental device is received by the server computational device from the dental imaging system.

5. The method of claim 1, the method further comprising:
sending a check or an electronic payment based on the amount of the discount.

6. The method of claim 5, wherein the check or the electronic payment is based on the amount of the discount is sent subsequent to the dental imaging system being fully paid for.

7. The method of claim 1, the method further comprising:
displaying, on a display screen of the intra-oral imaging system, a selection for sending the order to fabricate the dental device to the server computational device with an indication of the discount.

8. The method of claim 7, the method further comprising:
storing, by the server computational device, the dental imagery in a format suitable for being interpreted by devices that are different from the server computational device, wherein no discount or charges are applied for the storing, in response to not selecting the selection for sending the order to fabricate the dental device to the server computational device.

9. The method of claim 8, wherein the format is Standard Tessellation Language (STL) file format.

10. The method of claim 1, the method further comprising:
associating the dental imaging system with an account number, wherein the discount is associated with the account number; and
in response to a replacement of the dental imaging system by a new dental imaging system, associating the new dental imaging system with the account number.

11. The method of claim 1, wherein the discount is a function of a number of orders previously placed.

12. A system in communication with a dental imaging system, the system comprising:
a memory; and
a processor coupled to the memory, wherein the processor is configured to perform operations, the operations comprising:
establishing, by a server computational device, communications over a network with a dental imaging system;
receiving, an order to fabricate a dental device based on dental imagery acquired via the dental imaging system; and
computing and communicating a discount based on a cost of fabrication of the dental device.

13. The system of claim 12, wherein the dental imaging system is an intra-oral imaging system, the operations further comprising:
reducing a periodic payment for the dental imaging system by the amount of the discount.

14. The system of claim 13, the operations further comprising:
processing an amount for a check or an electronic payment based on the amount of the discount, wherein the check or the electronic payment is based on the amount of the discount is sent subsequent to the dental imaging system being fully paid for.

15. A computer readable storage medium, wherein code stored in the computer readable storage medium when executed by a processor of a server computational device performs operations, the operations comprising:
establishing, by the server computational device, communications over a network with a dental imaging system;
receiving, an order to fabricate a dental device based on dental imagery acquired via the dental imaging system; and
computing and communicating a discount based on a cost of fabrication of the dental device.

16. The computer readable storage medium of claim 15, wherein the dental imaging system is an intra-oral imaging system, the operations further comprising:
reducing a periodic payment for the dental imaging system by the amount of the discount.

17. The computer readable storage medium of claim 16, the operations further comprising:
sending a check or an electronic payment based on the amount of the discount, wherein the check or the electronic payment is based on the amount of the discount is sent subsequent to the dental imaging system being fully paid for.

18. An intra-oral imaging system configured for communication with a server computational system over a network, the intra-oral imaging system comprising:
an intra-oral imaging sensor;
a display; and
a processor coupled to the intra-oral imaging sensor and the display, wherein the processor performs operations, the operations comprising:
acquiring dental imagery;
establishing, communications over the network with the server computational system;
sending, an order to fabricate a dental device based on the acquired dental imagery; and
receiving communications of a discount based on a cost of fabrication of the dental device.

19. The intra-oral imaging system of claim 18, wherein a periodic payment for the dental imaging system is reduced by the amount of the discount.

20. The intra-oral imaging system of claim 19, wherein a check or an electronic payment based on the amount of the discount is received, subsequent to the intra-oral imaging system being fully paid for.
